(19) United States
(12) Patent Application Publication
(10) Pub. No.: US 2019/0354281 A1
(43) Pub. Date: Nov. 21, 2019

(54) AUTOMATED MOBILE DEVICE INTERFACE PREDICTION AND DETECTION

(71) Applicant: INTERNATIONAL BUSINESS MACHINES CORPORATION, Armonx, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 15/980,251

(22) Filed: May 15, 2018

(51) Int. Cl. G06F 3/0488; G06F 17/30; G06F 9/451; G06N 5/04; H04L 29/08

(52) U.S. Cl. CPC G06F 3/04886; G06F 17/30876; H04L 67/306; G06N 5/04; G06F 9/451

(57) ABSTRACT

A method and system for improving an automated mobile device prediction and detection system is provided. The method includes automatically determining a user interaction portion of a mobile device. Predictive content keyboard functionality with respect to a GUI of the mobile is determined and device is enabled and associated sensor data is analyzed. A specified body part of the user being utilized for supporting the mobile hardware device is determined and a portion of the user interaction portion for presenting predictive content is additionally determined. In response, the GUI is modified. Input text data is received from the user and associated predictive terms are presented via the modified GUI such that the predictive terms are accessible via a portion of the specified body part of the user. A selection for a first predictive term of the predictive terms is received via the modified GUI.

### FIELD

The present invention relates generally to a method for automatically determining predictive terms of a GUI and in particular to a method and associated system for improving mobile hardware device charging GUI modification technology associated with detecting a user interaction portion of a GUI of a device and modifying the GUI such that a user may efficiently enable the modified GUI.

### BACKGROUND

Accurately detecting interface functions for a device typically includes an inaccurate process with little flexibility. Determining faulty interface portions of devices may include a complicated process that may be time consuming and require a large amount of resources. Accordingly, there exists a need in the art to overcome at least some of the deficiencies and limitations described herein above.

### SUMMARY

A first aspect of the invention provides an automated mobile device prediction and detection improvement method comprising: automatically determining, by a processor of a mobile hardware device of a user, a user interaction portion of the mobile device, wherein the user interaction portion of the mobile hardware device is associated with executing predictive content selection actions; enabling, by the processor in response to a command from the user, predictive content keyboard functionality with respect to a graphical user interface (GUI) of the mobile hardware device; analyzing, by the processor, sensor data retrieved from sensors of the mobile hardware device; determining, by the processor based on results of the analyzing, a specified body part of the user currently being utilized for supporting and retaining the mobile hardware device; determining, by the processor based on results of the determining, a specified portion of the user interaction portion for presenting predictive content associated with input data retrieved via a keyboard of the GUI; modifying, by the processor based on the results of the determining, the GUI such that the specified portion of the user interaction portion is presented at a specified location of the GUI associated with the specified body part of the user; receiving, by the processor from the user, input text data; presenting, by the processor within the specified portion of the user interaction portion at specified location of the GUI, predictive terms associated with the input text data such that the predictive terms are accessible via a portion of the specified body part of the user; and retrieving, by the processor via the portion of the specified body part of the user, a selection of a first predictive term of the predictive terms.

A second aspect of the invention provides a computer program product, comprising a computer readable hardware storage device storing a computer readable program code, the computer readable program code comprising an algorithm that when executed by a processor of a mobile hardware device of a user implements an automated mobile device prediction and detection improvement method, the method comprising: automatically determining, by the processor, a user interaction portion of the mobile device, wherein the user interaction portion of the mobile hardware device is associated with executing predictive content selection actions; enabling, by the processor in response to a command from the user, predictive content keyboard functionality with respect to a graphical user interface (GUI) of the mobile hardware device; analyzing, by the processor, sensor data retrieved from sensors of the mobile hardware device; determining, by the processor based on results of the analyzing, a specified body part of the user currently being utilized for supporting and retaining the mobile hardware device; determining, by the processor based on results of the determining, a specified portion of the user interaction portion for presenting predictive content associated with input data retrieved via a keyboard of the GUI; modifying, by the processor based on the results of the determining, the GUI such that the specified portion of the user interaction portion is presented at a specified location of the GUI associated with the specified body part of the user; receiving, by the processor from the user, input text data; presenting, by the processor within the specified portion of the user interaction portion at specified location of the GUI, predictive terms associated with the input text data such that the predictive terms are accessible via a portion of the specified body part of the user; and retrieving, by the processor via the portion of the specified body part of the user, a selection of a first predictive term of the predictive terms.

A third aspect of the invention provides a mobile hardware device comprising a processor coupled to a computer-readable memory unit, the memory unit comprising instructions that when executed by the computer processor implements an automated mobile device prediction and detection improvement method comprising: automatically determining, by the processor, a user interaction portion of the mobile device, wherein the user interaction portion of the mobile hardware device is associated with executing predictive content selection actions; enabling, by the processor in response to a command from the user, predictive content keyboard functionality with respect to a graphical user interface (GUI) of the mobile hardware device; analyzing, by the processor, sensor data retrieved from sensors of the mobile hardware device; determining, by the processor based on results of the analyzing, a specified body part of the user currently being utilized for supporting and retaining the mobile hardware device; determining, by the processor based on results of the determining, a specified portion of the user interaction portion for presenting predictive content associated with input data retrieved via a keyboard of the GUI; modifying, by the processor based on the results of the determining, the GUI such that the specified portion of the user interaction portion is presented at a specified location of the GUI associated with the specified body part of the user; receiving, by the processor from the user, input text data; presenting, by the processor within the specified portion of the user interaction portion at specified location of the GUI, predictive terms associated with the input text data such that the predictive terms are accessible via a portion of the specified body part of the user; and retrieving, by the processor via the portion of the specified body part of the user, a selection of a first predictive term of the predictive terms.

The present invention advantageously provides a simple method and associated system capable of accurately detecting interface functions for a device.

### BRIEF DESCRIPTION OF THE DRAWINGS

FIG. 1 illustrates a system for improving mobile hardware device graphical user interface (GUI) modification technology associated with detecting a user interaction portion of a GUI of a mobile hardware device and modifying the GUI such that a user may efficiently enable the modified GUI, in accordance with embodiments of the present invention.

FIG. 2 illustrates an algorithm detailing a process flow enabled by the system of FIG. 1 for improving mobile hardware device GUI modification technology associated with detecting a user interaction portion of a GUI of a mobile hardware device and modifying the GUI such that a user may efficiently enable the modified GUI, in accordance with embodiments of the present invention.

FIG. 3 illustrates a perspective view of a mobile hardware device associated with a modified GUI, in accordance with embodiments of the present invention.

FIG. 4 illustrates a detailed view of a mobile hardware device associated with a modified GUI, in accordance with embodiments of the present invention.

FIG. 5 illustrates a left-handed view and a right-handed view of a mobile hardware device associated with a modified GUI, in accordance with embodiments of the present invention.

FIG. 6 illustrates a computer system used by the system of FIG. 1 for enabling a process for improving mobile hardware device GUI modification technology associated with detecting a user interaction portion of a GUI of a mobile hardware device and modifying the GUI such that a user may efficiently enable the modified GUI, in accordance with embodiments of the present invention.

FIG. 7 illustrates a cloud computing environment, in accordance with embodiments of the present invention.

FIG. 8 illustrates a set of functional abstraction layers provided by cloud computing environment, in accordance with embodiments of the present invention.

### DETAILED DESCRIPTION

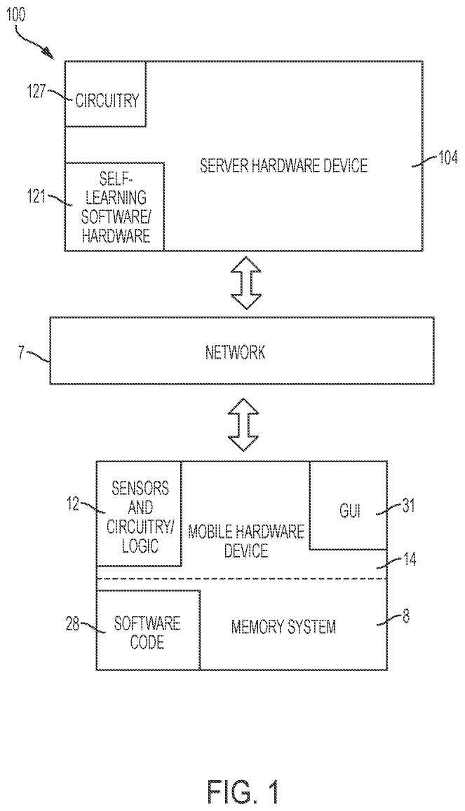

FIG. 1 illustrates a system 100 for improving mobile hardware device GUI modification technology associated with detecting a user interaction portion of a GUI of a mobile hardware device 14 and modifying the GUI such that a user may efficiently enable the modified GUI, in accordance with embodiments of the present invention. System 100 is enabled to generate and present predictive keywords to assist a user entering input data on mobile hardware device 14. A GUI of the mobile hardware device 14 is configured to automatically align (within the GUI) the predictive keywords with a user's finger (e.g., a thumb) such that the user may operate and interact with a (virtual) keyboard (of the GUI) with specified fingers on one hand and select predictive keywords (from a specified content panel of the GUI) with a thumb of the other hand as the user cradles the mobile hardware device 14. The GUI may additionally enable an inclined GUI panel to eliminate a reduction in a content window while simultaneously providing presentation space for multiple predicted content choices.

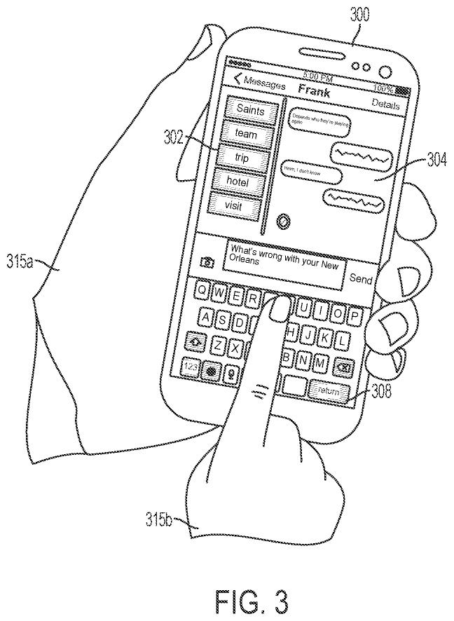

System 100 enables a process for allowing a user to access (via mobile hardware device 14) an application requiring text entry (e.g., entering a text message, composing an email, etc.). In response, circuitry and logic of the mobile hardware device 14 generates a predictive text element such as, inter alia, predicting a next word in a sentence, predicting a response to a question, etc. A GUI of mobile hardware device 14 arranges a presentation layout such that a virtual keyboard is arranged across the bottom of the GUI. Likewise, the GUI is automatically configured to position a text entry window in an inclined position and a predictive content window within reach of the user's thumb thereby enabling the user to enter text using a finger of one hand and selects predictive content using a thumb of the other hand cradling the phone (as illustrated, infra, with respect to FIG. 3). The GUI may be configured and adjusted with respect to whether the user is holding mobile hardware device 14 in a left or right hand. Mobile device 14 may comprise sensors such as, inter alia, an accelerometer, gyroscope, a temperature sensor, a pressure sensor, etc. for determining if the user is holding mobile hardware device 14 in a left or right hand.

System 100 of FIG. 1 includes a server hardware device 104 (i.e., specialized hardware device) connected through a network 7 to a mobile hardware device 14 (i.e., specialized hardware device). Server hardware device 104 includes specialized circuitry 127 (that may include specialized software) and self-learning software code/hardware structure 121 (i.e., including self-learning software code). Mobile hardware device 14 comprises sensors and circuitry/logic 12 and a (specialized) memory system 8. Memory system 8 comprises software code 28. Memory system 8 may include a single memory system. Alternatively, memory system 8 may include a plurality of memory systems. Server hardware device 104 and mobile hardware device 14 each may comprise an embedded device. An embedded device is defined herein as a dedicated device or computer comprising a combination of computer hardware and software (fixed in capability or programmable) specifically designed for executing a specialized function. Programmable embedded computers or devices may comprise specialized programming interfaces. In one embodiment, server hardware device 104 and mobile hardware device 14 may each comprise a specialized hardware device comprising specialized (non-generic) hardware and circuitry (i.e., specialized discrete non-generic analog, digital, and logic based circuitry) for (independently or in combination) executing a process described with respect to FIGS. 1-8. The specialized discrete non-generic analog, digital, and logic based circuitry (e.g., sensors and circuitry/logic 12, etc.) may include proprietary specially designed components (e.g., a specialized integrated circuit, such as for example an Application Specific Integrated Circuit (ASIC) designed for only implementing a process for improving mobile hardware device GUI modification technology associated with detecting a user interaction portion of a GUI of a mobile hardware device 14 and modifying the GUI such that a user may efficiently enable the modified GUI. Sensors and circuitry/logic 12 may include sensors including, inter alia, accelerometers (for determining an orientation or a pattern of movement (e.g., a vibration) with respect to mobile hardware device 14), a gyroscope to determine a positional angle of mobile hardware device 14, light detection sensors, a barometer sensor, and audio sensors; GPS sensors, optical sensors, temperature sensors, voltage sensors, motion sensors, pressure sensors, etc. Sensors and circuitry/logic 12 may include electronic switches for activating portions of the modified GUI. Network 7 may include any type of network including, inter alia, a local area network, (LAN), a wide area network (WAN), the Internet, a wireless network, etc.

System 100 is enabled to present a predictive content panel GUI (based on a message content and associated text entry) at a position located at a top left or right portion of the GUI in accordance with an alignment with the user's thumb. Likewise, a width of a main content window may remain unchanged via usage of an inclined GUI window. Therefore, system 100 allows a user to enter input text via usage a finger on a free hand and select predictive keyword options via usage of a thumb of another hand cradling the mobile hardware device 14. System enables a process for aligning and scaling the predictive content panel with a thumb of a hand cradling the mobile device based detection of a left and right hand.

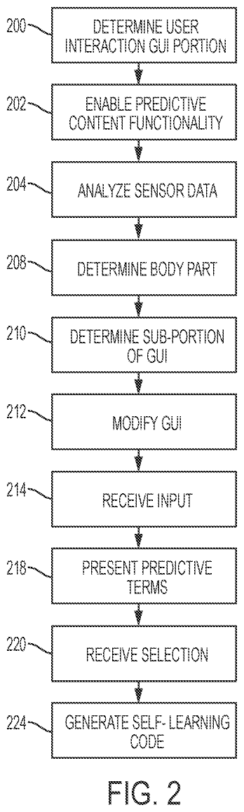

FIG. 2 illustrates an algorithm detailing a process flow enabled by system 100 of FIG. 1 for improving mobile hardware device graphical user interface (GUI) modification technology associated with detecting a user interaction portion of a GUI of mobile hardware device 14 and modifying the GUI such that a user may efficiently enable the modified GUI, in accordance with embodiments of the present invention. Each of the steps in the algorithm of FIG. 2 may be enabled and executed in any order by a computer processor(s) executing computer code. Additionally, each of the steps in the algorithm of FIG. 2 may be enabled and executed in combination by mobile hardware device 14 and server hardware devices 104 of FIG. 1. In step 200, a user interaction portion of a mobile hardware device is automatically determined. The user interaction portion is associated with executing predictive content selection actions. Automatically determining the user interaction portion may include retrieving (from a remote database) a user profile describing user reachable portions of the user interaction portion. Alternatively, automatically determining the user interaction portion may include detecting (via sensors) a portion of a specified body part (e.g., a thumb) of the user currently able to access the user interaction portion. In step 202, predictive content keyboard functionality with respect to a graphical user interface (GUI) of the mobile hardware device is enabled in response to a command from the user. In step 204, sensor data retrieved from sensors of the mobile hardware device is analyzed. The sensors may include an accelerometer and a gyroscope and the analysis may include: detecting (via the accelerometer) vibrations initiated via a specified body part of the user; and detecting (via the gyroscope) an angle of the specified body part of the user with respect to the mobile hardware device. Alternatively, the sensors may include a temperature sensor or a pressure sensor and the analysis may include: detecting a temperature of the mobile hardware device with respect to contact with a specified body part of the user or a pressure applied to the mobile hardware device with respect to contact with a specified body part of the user. In step 208, a specified body part (e.g., a right or left hand) of the user currently being utilized for supporting and retaining the mobile hardware device is determined based on results of the analysis of step 204. In step 210, a specified portion of the user interaction portion is determined for presenting predictive content associated with input data retrieved via a keyboard of the GUI determining. In step 212, the GUI is modified (e.g., via a size scaling process of the user interaction portion based on a detected size or shape of the specified body part detected via sensors) such that the specified portion of the user interaction portion is presented at a specified location of the GUI associated with the specified body part of the user. In step 214, input text data is received from the user via a keyboard of the GUI. In step 218, predictive terms associated with the input text data are presented within the specified portion of the user interaction portion at a specified location of the GUI such that the predictive terms are accessible via a portion of the specified body part (e.g., a thumb) of said user. In step 220, a selection of a first predictive term is retrieved via the portion of the specified body part of the user. In step 224, self-learning computer code is generated based on analysis of the modifying of step 212. The self-learning software code is configured to be executed for predicting additional modifications of additional GUIs of mobile devices of the user.

FIG. 3 illustrates a perspective view of a mobile hardware device 300 associated with a modified GUI, in accordance with embodiments of the present invention. The GUI of mobile hardware device 300 comprises a keyboard portion 308 (being activated by a right hand 315b of a user), a text chat (content) window 304 (at a specified location within the GUI) presented with respect to an inclined position for virtually increasing a size of the window, and a predicted keyword selection portion 302 being activated via a thumb of a left hand 315a of the user.

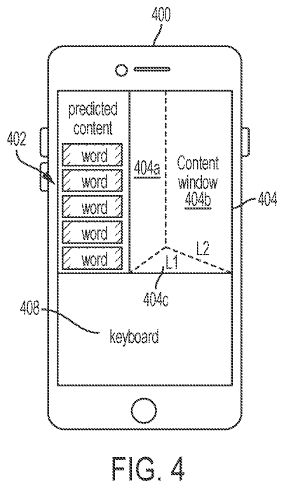

FIG. 4 illustrates a detailed view of a mobile hardware device 400 associated with a modified GUI, in accordance with embodiments of the present invention. The GUI of mobile hardware device 400 comprises a keyboard portion 408, a content window 404 (at a specified location within the GUI) comprising portions 404a, 404b, and 404c for presenting an inclined position for virtually increasing a size of the window, and a predicted keyword selection portion 402. Keyboard portion 408 comprises a virtual keyboard is displayed on mobile hardware device 400. Predicted keyword selection portion 402 resides directly above keyboard portion 408 thereby leaving more space for content window 404. Content window 404 (comprising portions 404a, 404b, and 404c) displays text being entered (e.g., a messaging application, an email, etc.). Content window 404 presented via an inclined position to compensate for a reduced area for predicted keyword selection portion 402. Presenting content window 404 in inclined position allows an effective width of content window 404 to remain a same size. Predicted keyword selection portion 402 displays the predicted keyword choices in a vertical format for presentation of multiple keywords for selection.

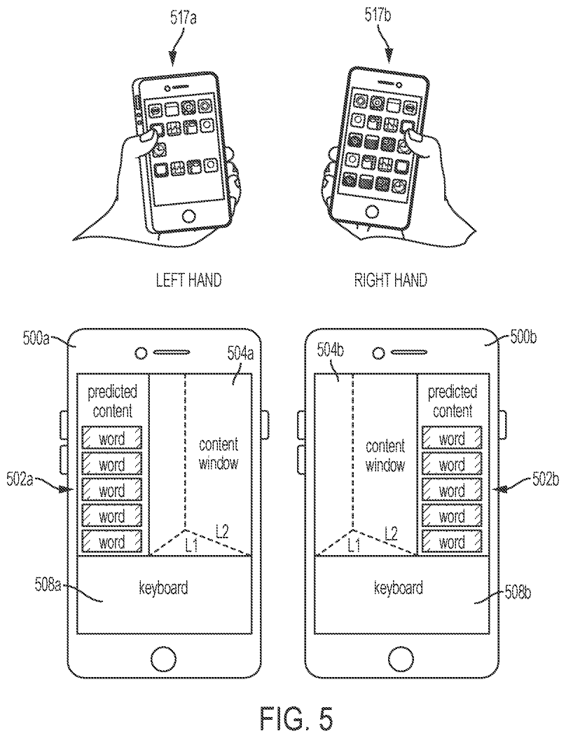

FIG. 5 illustrates a left-handed view 517a and a right-handed view 517b of a mobile hardware device associated with a modified GUI, in accordance with embodiments of the present invention. Left handed view 517a illustrates a mobile device GUI 500a associated with a lefthanded configuration comprising keyboard portion 508a, a content window 504a (at a right-side location within the GUI 500a), and a predicted keyword selection portion 502a (at a left side location within the GUI 500a). Alternatively, right handed view 517b illustrates mobile device GUI 500b associated with a righthanded configuration comprising keyboard portion 508b, a content window 504b (at a left side location within the GUI 500b), and a predicted keyword selection portion 502b (at a right-side location within the GUI 500b). Therefore, the mobile hardware device is configured to consider which hand the mobile hardware device is being held to configure (via usage of sensor data from, inter alia, an accelerometer, a gyroscope, etc.) the predictive content panel to be aligned with a thumb of a user hand currently cradling the mobile hardware device.

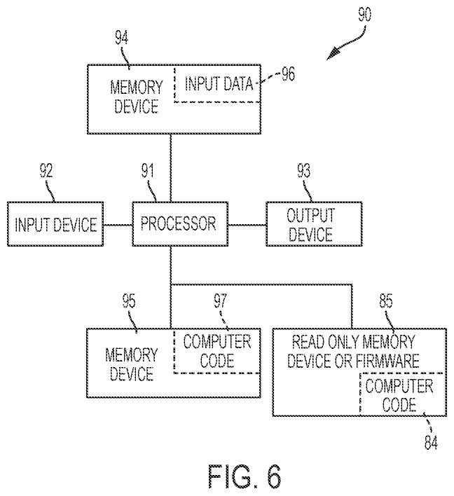

FIG. 6 illustrates a computer system 90 (e.g., mobile hardware device 14 and server hardware device 104 of FIG. 1) used by or comprised by the system of FIG. 1 for improving mobile hardware device GUI modification technology associated with detecting a user interaction portion of a GUI of a mobile hardware device 14 and modifying the GUI such that a user may efficiently enable the modified GUI, in accordance with embodiments of the present invention.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 6 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for improving mobile hardware device GUI modification technology associated with detecting a user interaction portion of a GUI of a mobile hardware device 14 and modifying the GUI such that a user may efficiently enable the modified GUI. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices Such as read only memory device 96) may include algorithms (e.g., the algorithm of FIG. 2) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including algorithms) may be stored on a static, nonremovable, read-only storage medium such as a Read-Only Memory (ROM) device 85, or may be accessed by processor 91 directly from such a static, nonremovable, read-only medium 85. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve mobile hardware device GUI modification technology associated with detecting a user interaction portion of a GUI of a mobile hardware device 14 and modifying the GUI such that a user may efficiently enable the modified GUI. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving mobile hardware device GUI modification technology associated with detecting a user interaction portion of a GUI of a mobile hardware device 14 and modifying the GUI such that a user may efficiently enable the modified GUI. In another embodiment, the invention provides a business method that performs the process steps of the invention on a subscription, advertising, and/or fee basis. That is, a service supplier, such as a Solution Integrator, could offer to enable a process for improving mobile hardware device GUI modification technology associated with detecting a user interaction portion of a GUI of a mobile hardware device and modifying the GUI such that a user may efficiently enable the modified GUI. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

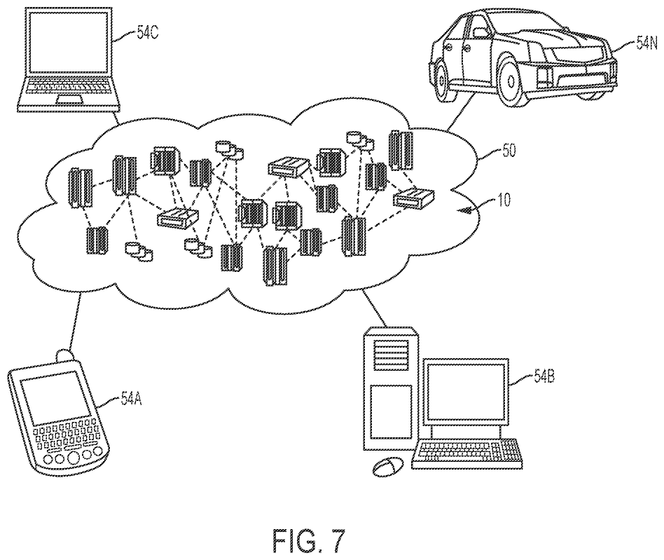

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 4 are intended to be illustrative only and that computing nodes 10 and cloud computing environment 50 can communicate with any type of computerized device over any type of network and/or network addressable connection (e.g., using a web browser).

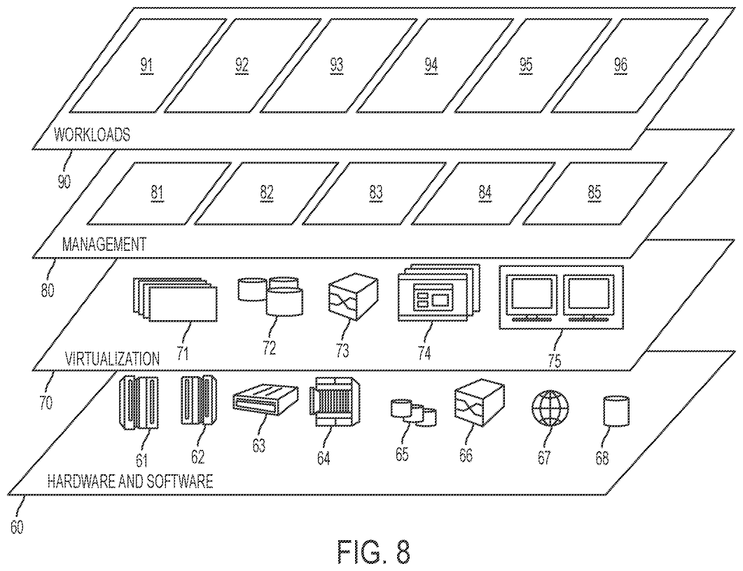

Referring now to FIG. 8, a set of functional abstraction layers provided by cloud computing environment 50 (see FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 89 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for improving mobile hardware device GUI modification technology associated with detecting a user interaction portion of a GUI of a mobile hardware device and modifying the GUI such that a user may efficiently enable the modified GUI.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. An automated mobile device prediction and detection improvement method comprising:
automatically determining, by a processor of a mobile hardware device of a user, a user interaction portion of said mobile device, wherein said user interaction portion of said mobile hardware device is associated with executing predictive content selection actions;
enabling, by said processor in response to a command from said user, predictive content keyboard functionality with respect to a graphical user interface (GUI) of said mobile hardware device;
analyzing, by said processor, sensor data retrieved from sensors of said mobile hardware device;
determining, by said processor based on results of said analyzing, a specified body part of said user currently being utilized for supporting and retaining said mobile hardware device;
determining, by said processor based on results of said determining, a specified portion of said user interaction portion for presenting predictive content associated with input data retrieved via a keyboard of said GUI;
modifying, by said processor based on said results of said determining, said GUI such that said specified portion of said user interaction portion is presented at a specified location of said GUI associated with said specified body part of said user;
receiving, by said processor from said user, input text data;
presenting, by said processor within said specified portion of said user interaction portion at specified location of said GUI, predictive terms associated with said input text data such that said predictive terms are accessible via a portion of said specified body part of said user; and
retrieving, by said processor via said portion of said specified body part of said user, a selection of a first predictive term of said predictive terms.

2. The method of claim 1, wherein said automatically determining said user interaction portion of said mobile device comprises:
retrieving, by said processor from a remote database, a user profile describing user reachable portions of said user interaction portion.

3. The method of claim 1, wherein said automatically determining said user interaction portion of said mobile device comprises:
detecting, by said processor via said sensors, said portion of said specified body part of said user currently able to access said user interaction portion.

3. The method of claim 1, wherein said user interaction portion of said mobile is reachable via a thumb of said user.

4. The method of claim 1, wherein said sensors comprise an accelerometer and a gyroscope and wherein said analyzing comprises:
detecting, by said processor via said accelerometer, vibrations initiated via said specified body part of said user; and
detecting, by said processor via said gyroscope, an angle of said specified body part of said user with respect to said mobile hardware device.

5. The method of claim 1, wherein said sensors comprise a temperature sensor, and wherein said analyzing comprises:
detecting, by said processor via said temperature sensor, a temperature of said mobile hardware device with respect to contact with said specified body part of said user.

6. The method of claim 1, wherein said sensors comprise pressure sensor, and wherein said analyzing comprises:
detecting, by said processor via said pressure sensor, a pressure applied to said mobile hardware device with respect to contact with said specified body part of said user.

7. The method of claim 1, wherein said specified body part of said user comprises a hand of said user, and wherein said portion of said specified body part comprises a thumb of said user.

8. The method of claim 1, wherein said modifying further comprises scaling a size of said specified portion of said user interaction portion based on a detected size and shape of said specified body part of said user.

9. The method of claim 8, wherein said detected size and shape of said specified body part of said user is detected via said sensors.

10. The method of claim 1, further comprising:
generating, by said processor based on analysis of said modifying, self-learning computer code configured to be executed for predicting additional modifications of additional GUIs of mobile devices of said user.

11. The method of claim 1, further comprising:
providing at least one support service for at least one of creating, integrating, hosting, maintaining, and deploying computer-readable code in the control hardware, said code being executed by the computer processor to implement: said automatically determining, said enabling, said analyzing, said determining said specified body part, said determining said specified portion, said modifying, said receiving, said presenting, and said retrieving.

12. A computer program product, comprising a computer readable hardware storage device storing a computer readable program code, said computer readable program code comprising an algorithm that when executed by a processor of a mobile hardware device of a user implements an automated mobile device prediction and detection improvement method, said method comprising:
automatically determining, by said processor, a user interaction portion of said mobile device, wherein said user interaction portion of said mobile hardware device is associated with executing predictive content selection actions;
enabling, by said processor in response to a command from said user, predictive content keyboard functionality with respect to a graphical user interface (GUI) of said mobile hardware device;
analyzing, by said processor, sensor data retrieved from sensors of said mobile hardware device;
determining, by said processor based on results of said analyzing, a specified body part of said user currently being utilized for supporting and retaining said mobile hardware device;
determining, by said processor based on results of said determining, a specified portion of said user interaction portion for presenting predictive content associated with input data retrieved via a keyboard of said GUI;
modifying, by said processor based on said results of said determining, said GUI such that said specified portion of said user interaction portion is presented at a specified location of said GUI associated with said specified body part of said user;
receiving, by said processor from said user, input text data;
presenting, by said processor within said specified portion of said user interaction portion at specified location of said GUI, predictive terms associated with said input text data such that said predictive terms are accessible via a portion of said specified body part of said user; and
retrieving, by said processor via said portion of said specified body part of said user, a selection of a first predictive term of said predictive terms.

13. The computer program product of claim 12, wherein said automatically determining said user interaction portion of said mobile device comprises:
retrieving, by said processor from a remote database, a user profile describing user reachable portions of said user interaction portion.

14. The computer program product of claim 12, wherein said automatically determining said user interaction portion of said mobile device comprises:
detecting, by said processor via said sensors, said portion of said specified body part of said user currently able to access said user interaction portion.

15. The computer program product of claim 12, wherein said user interaction portion of said mobile is reachable via a thumb of said user.

16. The computer program product of claim 12, wherein said sensors comprise an accelerometer and a gyroscope and wherein said analyzing comprises:
detecting, by said processor via said accelerometer, vibrations initiated via said specified body part of said user; and
detecting, by said processor via said gyroscope, an angle of said specified body part of said user with respect to said mobile hardware device.

17. The computer program product of claim 12, wherein said sensors comprise a temperature sensor, and wherein said analyzing comprises:
detecting, by said processor via said temperature sensor, a temperature of said mobile hardware device with respect to contact with said specified body part of said user.

18. The computer program product of claim 12, wherein said sensors comprise pressure sensor, and wherein said analyzing comprises:
detecting, by said processor via said pressure sensor, a pressure applied to said mobile hardware device with respect to contact with said specified body part of said user.

19. The computer program product of claim 12, wherein said specified body part of said user comprises a hand of said user, and wherein said portion of said specified body part comprises a thumb of said user.

20. A mobile hardware device comprising a processor coupled to a computer-readable memory unit, said memory unit comprising instructions that when executed by the computer processor implements an automated mobile device prediction and detection improvement method comprising:
automatically determining, by said processor, a user interaction portion of said mobile device, wherein said user interaction portion of said mobile hardware device is associated with executing predictive content selection actions;
enabling, by said processor in response to a command from said user, predictive content keyboard functionality with respect to a graphical user interface (GUI) of said mobile hardware device;
analyzing, by said processor, sensor data retrieved from sensors of said mobile hardware device;
determining, by said processor based on results of said analyzing, a specified body part of said user currently being utilized for supporting and retaining said mobile hardware device;
determining, by said processor based on results of said determining, a specified portion of said user interaction portion for presenting predictive content associated with input data retrieved via a keyboard of said GUI;
modifying, by said processor based on said results of said determining, said GUI such that said specified portion of said user interaction portion is presented at a specified location of said GUI associated with said specified body part of said user;
receiving, by said processor from said user, input text data;
presenting, by said processor within said specified portion of said user interaction portion at specified location of said GUI, predictive terms associated with said input text data such that said predictive terms are accessible via a portion of said specified body part of said user; and
retrieving, by said processor via said portion of said specified body part of said user, a selection of a first predictive term of said predictive terms.
